(19) United States
(12) Patent Application Publication
(10) Pub. No.: US 2021/0283916 A1
(43) Pub. Date: Sep. 16, 2021

(54) Ink Jet Printing Apparatus And Maintenance Method

(71) Applicant: Seiko Epson Corporation, Tokyo (JP)

(72) Inventors: Tasuku NAKAMURA, Matsumoto (JP); Hideki OKADA, Shiojiri (JP)

(21) Appl. No.: 17/195,853

(22) Filed: Mar. 9, 2021

(30) Foreign Application Priority Data
Mar. 10, 2020 (JP) 2020-040694

(51) Int. Cl. B41J 2/165; C09D 11/30

(52) U.S. Cl. CPC B41J 2/16552; B41J 2002/16558; C09D 11/30; B41J 2/16526

(57) ABSTRACT

An ink jet printing apparatus includes a printing head that has a nozzle face and a nozzle having an ejection opening defined in the nozzle face and through which an ink composition is ejected, and a pressure cleaning mechanism configured to apply a pressure to an interior of the printing head to discharge the ink composition from the nozzle for cleaning. The ink composition contains resin particles having a glass transition temperature of −30° C. to 50° C., an organic solvent having a normal boiling point of 280° C. or more, at least one of organic and inorganic alkalis, and at least one of betaines and polyhydric alcohols being solid at room temperature.

The present application is based on, and claims priority from JP Application Serial Number 2020-040694, filed Mar. 10, 2020, the disclosure of which is hereby incorporated by reference herein in its entirety.

### BACKGROUND

### 1. Technical Field

The present disclosure relates to an ink jet printing apparatus and a maintenance method.

### 2. Related Art

Ink jet printing methods, which enable high-definition printing with a relatively simple apparatus, continue to be rapidly developed in various fields. Under such circumstances, various cleaning methods for ink jet printing apparatuses have been proposed. For example, JP-A-2017-013301 discloses a liquid ejecting apparatus that enables appropriate maintenance of the ejection head having nozzles while suppressing the waste of liquid. In this apparatus, the ejection head is subjected to cleaning by increasing the liquid pressure in the nozzles.

However, such pressure cleaning is not much effective in the case of using ink compositions containing solids such as resin particles for increasing the fastness to rubbing, and the nozzles are not always sufficiently recovered from clogging. A printing apparatus that not only produces printed items with high fastness to rubbing but also enables high-performance cleaning (satisfactory recovery from clogging) is desirable.

### SUMMARY

The present disclosure provides an ink jet printing apparatus including a printing head that has a nozzle face and a nozzle having an ejection opening defined in the nozzle face and through which an ink composition is ejected, and a pressure cleaning mechanism configured to apply a pressure to an interior of the printing head to discharge the ink composition from the nozzle for cleaning. The ink composition contains resin particles having a glass transition temperature of −30° C. to 50° C., an organic solvent having a normal boiling point of 280° C. or more, at least one of organic and inorganic alkalis, and at least one of polyhydric alcohols being solid at room temperature and betaines.

The resin particles in the ink composition used in the ink jet printing apparatus may contain a crosslinkable group.

The resin particles in the ink composition may include urethane resin particles.

The resin particle content in the ink composition may be 3.0% to 8.0% relative to the total mass of the ink composition.

The total organic and inorganic alkali content in the ink composition may be, by mass, 0.10 to 0.60 relative to the total content of the polyhydric alcohols and betaines.

The resin particle content in the ink composition may be, by mass, 1.0 to 2.0 relative to the total content of the polyhydric alcohols and betaines.

The ink jet printing apparatus may further include a wipe cleaning mechanism including an absorbent member and operable to wipe the nozzle face with the absorbent member.

The absorbent member may be impregnated with a cleaning liquid having a surface tension of 0.75 to 1.25 relative to the surface tension of the ink composition.

The contact angle of the cleaning liquid with the nozzle face may be 1.3 to 1.7 relative to the contact angle of the ink composition with the nozzle face.

The present disclosure also provides a maintenance method for maintaining the ink jet printing apparatus. The method includes a pressure cleaning step of applying a pressure to an interior of the printing head to discharge the ink composition from the nozzle.

### BRIEF DESCRIPTION OF THE DRAWINGS

FIG. 1 is a schematic block diagram illustrating an arrangement of a printing head, an ink delivery mechanism, and a pressure cleaning mechanism.

FIG. 2 is a schematic view of the structure of a wipe cleaning mechanism.

### DESCRIPTION OF EXEMPLARY EMBODIMENTS

Some embodiments of the present disclosure will now be described in detail with reference to the drawings as needed. However, the implementation of the concept of the present disclosure is not limited to the embodiments described herein, and various modifications may be made without departing from the scope and spirit of the present disclosure. The same elements in the drawings are designated by the same reference numerals, and thus description thereof is omitted. The relative positions and other positional relationships are in accordance with the drawings unless otherwise specified. The dimensional proportions in the drawings are not limited to those illustrated in the drawings.

### 1. Ink Jet Printing Apparatus

The ink jet printing apparatus disclosed herein includes a printing head that has a nozzle face and a nozzle having an ejection opening defined in the nozzle face and through which an ink composition is ejected, and a pressure cleaning mechanism configured to apply a pressure to an interior of the printing head to discharge the ink composition through the nozzle for cleaning. The ink composition contains resin particles having a glass transition temperature of −30° C. to 50° C., an organic solvent having a normal boiling point of 280° C. or more, at least one of organic and inorganic alkalis, and at least one of polyhydric alcohols that are solid at room temperature and betaines.

In ink jet ink printing apparatuses, which are a type of printing apparatus configured to eject an ink composition through nozzles, the nozzles are cleaned at regular intervals by discharging the ink composition from the nozzles from the viewpoint of preventing the ink composition from clogging the nozzles. Such discharge may be performed by pressure cleaning or vacuum cleaning, depending on how to apply pressure to the ink composition within the nozzles.

Pressure cleaning is a cleaning technique of discharging the ink composition from the nozzles by intermittently applying positive pressure to the ink composition within the nozzles in the downstream direction from the ink delivery channel toward the nozzles. In contrast, vacuum cleaning is another cleaning technique of applying negative pressure to the space defined by a cap covering the nozzle face with a suction pump or a negative pressure generator, thereby discharging the ink composition from the nozzles.

The ink composition to be discharged by such cleaning contains a coloring material and other constituents, such as resin particles. Ink compositions containing resin particles are likely to form aggregates in the nozzles, or to thicken depending on how dry the ink composition in the nozzles is. In particular, ink compositions containing resin particles having a glass transition temperature of −30° C. to 50° C. can increase the fastness to rubbing of the printed items but are, unfortunately, likely to form aggregates.

In general, pressure cleaning tends to be less effective than vacuum cleaning in discharging the ink composition. Therefore, pressure cleaning is not likely to achieve satisfactory cleaning performance in printing apparatuses using ink compositions containing resin particles having a glass transition temperature of −30° C. to 50° C.

In the ink composition used in the ink jet printing apparatus disclosed herein, an organic solvent having a normal boiling point of 280° C. or more, at least either an organic alkali or an inorganic alkali, and at least either a betaine or a polyhydric alcohol that is solid at room temperature are added to the ink composition containing resin particles so that sticking substances formed in the ink composition can disperse again, thus increasing the performance of pressure cleaning.

By enabling the use of pressure cleaning in the case of using ink compositions containing resin particles, as disclosed herein, air bubbles in the ink composition, which are likely to be formed by vacuum cleaning, can be reduced, and the ink composition becomes unlikely to stick to the nozzle face when being discharged for cleaning. Thus, pressure cleaning does not require to be followed by further cleaning, consequently reducing the total cleaning time compared to vacuum cleaning. An ink jet printing apparatus according to an embodiment of the present disclosure will now be described.

### 1. 1. Ink Composition

First, the ink composition will be described. The ink composition used in the ink jet printing apparatus disclosed herein contains resin particles having a glass transition temperature of −30° C. to 50° C., an organic solvent having a normal boiling point of 280° C. or more, at least one of organic and inorganic alkalis, and at least one polyhydric alcohols that are solid at room temperature and betaines.

### 1. 1. 1. Resin Particles

The glass transition temperature of the resin particles is −30° C. to 50° C. and, in some embodiments, may be −25° C. to 45° C., −20° C. to 45° C., or 10° C. to 45° C. Resin particles having a glass transition temperature of 50° C. or less can form a film at reduced temperature, thereby helping the printed ink fix tightly to the printing medium. Also, the texture of printed items becomes favorable. From the viewpoint of improving the texture, the glass transition temperature of the resin particles may be 0° C. or less. Resin particles having a glass transition temperature of −30° C. or more help increase the fastness of the coating of the ink composition. The glass transition temperature of the resin particles may be measured by differential scanning calorimetry (DSC) in accordance with JIS K7121: 1987. For this measurement, a differential scanning calorimeter DSC6220 (manufactured by Seiko Instruments) may be used.

The material of the resin particles may be, but is not limited to, urethane resin or (meth)acrylic resin. In some embodiments, urethane resin particles may be used. Such resin particles tend to be effective in reducing bleeding in the printed image and increasing the rub resistance of the image. The material of the resin particles may be an individual resin or a combination of two or more resins.

The urethane resin of the resin particles is a resin having a urethane bond in the molecule and is not otherwise limited. For example, the urethane resin may be polyether-type urethane resin further having an ether bond in the main chain, a polyester-type urethane resin further having an ester bond in the main chain, or a polycarbonate-type urethane resin further having a carbonate linkage in the main chain. A polyether-type or polycarbonate-type urethane resin may be selected. In some embodiment, a polycarbonate-type urethane resin may be used. From the viewpoint of increasing dispersion stability, particles of a urethane resin having at least any of a carboxy group, a sulfo group, and a hydroxy group may be used.

The acrylic resin of the resin particles may be, but is not limited to, a polymer of one or more (meth)acrylic monomers, such as (meth)acrylic acid and (meth)acrylic esters, or a copolymer of a (meth)acrylic monomer and other monomers. In an embodiment, anionic acrylic resin particles may be used.

The resin particles may contain a crosslinkable group. The crosslinkable group may react with the same crosslinkable group to form a crosslinked structure or react with a functional group different from the crosslinkable group to form a crosslinked structure. Resin particles having a crosslinkable group tend to be effective in increasing the fastness of the coating of the ink composition. Unfortunately, such resin particles easily form crosslinks and accordingly tend to cause the ink composition to clog the printing head and result in reduced cleaning performance. The concept of the present disclosure is useful to such a case.

The crosslinkable group may be, but is not limited to, a blocked isocyanate group, a silanol group that may or may not be protected by a protective group. Examples of the silanol group include, but are not limited to, triethoxysilyl, trimethoxysilyl, and tris(2-methoxyethoxy)silyl. In some embodiments, resin particles having a blocked isocyanate group as the crosslinkable group may be used from the viewpoint of storage stability and reactivity. Blocked isocyanate is a structure in which a blocking agent blocks the isocyanate group. The blocking agent blocks and inactivates isocyanate groups and, after deblocking, reproduces and activates the isocyanate groups. Examples of the blocking agent include imidazole compounds, imidazoline compounds, pyrimidine compounds, guanidine compounds, alcohols, phenols, active methylene compounds, amines, imines, oximes, carbamic acid and derivatives thereof, urea compounds, acid amides (lactams), acid imides, triazoles, pyrazole-based compounds, mercaptans, and bisulfites. The crosslinkable group of the resin particles forms crosslinked structures among resin molecules or the like, thus increasing fastness to rubbing.

The urethane resin containing a crosslinkable group may be available in the form of dispersion, and examples thereof include, but are not limited to, AKELAC WS-6021 (emulsion of polyether-based polyurethane resin having a polyether-derived skeleton, produced by Mitsui Chemicals, Inc.), AKELAC WS-5100 (emulsion of polycarbonate-based polyurethane resin having a polycarbonate-derived skeleton, produced by Mitsui Chemicals, Inc.), ELASTRON series H-38, BAP, C-52, F-29, and W-11P (all produced by DSK Co. Ltd.), ELASTRON series E-37 and H-3 (emulsion of polyester-based polyurethane resin having a polyester-derived skeleton, both produced by DSK Co. Ltd.), SUPERFLEX series 870, 800, 150, 420, 460, 470, 610, and 700 (urethane resin emulsions, all produced by DSK Co. Ltd.), PERMARIN UA-150 (urethane resin emulsion, produced by Sanyo Chemical Industries), Sancure 2710 (urethane resin emulsion produced by Lubrizol), NeoRez series R-9660, R-9637, and R-940 (urethane resin emulsions, produced by Kusumoto Chemicals), ADEKA Bon-Tighter series HUX-380 and 290K (urethane resin emulsions, both produced by ADEKA), and ETERNACOLL UW-1501F (urethane resin emulsion, produced by Ube Industries).

The resin particle content in the ink composition may be 2.0% to 10%, for example, 3.0% to 8.0% or 3.0% to 6.0%, relative to the total mass of the ink composition. The ink composition containing 2.0% by mass or more of resin particles tends to further increase the fastness of the coating of the ink composition. Also, the ink composition containing 10% by mass or less of resin particles is less likely to clog the printing head.

The resin particle content may be, by mass, 0.6 to 3.0, for example, 1.0 to 2.0 or 1.2 to 1.8, relative to the total content of the polyhydric alcohols and betaines. When the resin particle content is in such a range, the ink composition tends to form coatings having high fastness and increase cleaning performance.

### 1. 1. 2. Organic Solvent Having a Normal Boiling Point of 280° C. or More

An example of the organic solvent having a normal boiling point of 280° C. or more is, but not limited to, glycerin. Such an organic solvent may be a compound containing carbon, hydrogen, and oxygen. In some embodiments, the organic solvent may be liquid at room temperature. Room temperature mentioned herein is 25° C.

The content of the organic solvent having a normal boiling point of 280° C. or more may be 3.5% to 17.5%, for example, 5.0% to 15% or 7.5% to 12.5%, relative to the total mass of the ink composition. When the content of the organic solvent having a normal boiling point of 280° C. or more is in such a range, the ink composition tends to exhibit high moisture-retaining property and increase cleaning performance and is less likely to clog the printing head.

### 1. 1. 3. Organic and Inorganic Alkalis

The organic alkali used in the ink composition may be an alkanolamine. Examples of alkanolamines include, but are not limited to, triethanolamine, diethanolamine, monoethanolamine, and tripropanolamine. The inorganic alkali may be, but is not limited to, lithium hydroxide, sodium hydroxide, or potassium hydroxide. In some embodiments, an organic alkali may be used. The use of such an alkali helps maintain the stable dispersion of the ink constituents, particularly of the resin particles, consequently reducing clogging and increasing cleaning performance.

The organic alkali content may be 0.05% to 3.0%, for example, 0.10% to 2.5%, 0.20% to 2.0%, or 0.20% to 0.75%, relative to the total mass of the ink composition. When the organic alkali content is in such a range, the stability of the dispersion of the ink constituents can be increased and, consequently, the ink composition becomes less likely to clog the printing head and tends to increase cleaning performance.

The inorganic alkali content may be 0.05% to 0.75%, for example, 0.05% to 0.50% or 0.05% to 0.30%, relative to the total mass of the ink composition. When the inorganic alkali content is in such a range, the stability of the dispersion of the ink constituents, particularly of the resin particles, can be increased, and, consequently, the ink composition becomes less likely to clog the printing head and tends to increase cleaning performance.

The total content of the organic and inorganic alkalis may be, by mass, 0.05% to 3.0%, for example, 0.10% to 2.5%, 0.20% to 2.0%, or 0.20% to 0.75%. When the total content of the organic and inorganic alkalis is in such a range, the stability of the dispersion of the ink constituents, particularly of the resin particles, can be increased, and, consequently, the ink composition becomes less likely to clog the printing head and tends to increase cleaning performance.

The total organic and inorganic alkali content may be, by mass, 0.05 to 0.90, for example, 0.10 to 0.60 or 0.10 to 0.40, relative to the total content of the polyhydric alcohols and betaines that will be described later herein. When the total organic and inorganic alkali content is in such a range, the stability of the dispersion of the ink constituents can be increased, and, consequently, the ink composition becomes less likely to clog the printing head and tends to increase cleaning performance. Also, the organic and inorganic alkalis in such a proportion are not likely to remain much in the printed item, resulting in increased fastness to rubbing.

1. 1. 4. Polyhydric Alcohol being Solid at Room Temperature

Examples of polyhydric alcohols that are solid at room temperature (hereinafter referred to as room-temperature-solid polyhydric alcohols) include, but are not limited to, trimethylolpropane, neopentyl glycol, and saccharides, such as glucose, mannose, fructose, ribose, xylose, arabinose, galactose, aldonic acid, glucitol (sorbitol), maltose, cellobiose, lactose, sucrose, trehalose, and maltotriose. In some embodiments, trimethylolpropane may be selected. Room temperature mentioned herein is 25° C.

The room-temperature-solid polyhydric alcohol content in the ink composition may be 0.5% to 7.5%, for example, 1.0% to 6.0% or 1.5% to 4.0%, relative to the total mass of the ink composition. When room-temperature-solid polyhydric alcohol content is in such a range, the ink composition tends to exhibit high moisture-retaining property and improved hygroscopicity and increase cleaning performance and is less likely to clog the printing head.

### 1. 1. 5. Betaine

The betaine in the ink composition used herein is a compound having both amino and carboxy groups. The amino group may be a tertiary or quaternary amino group from the viewpoint of stability. Examples of such a betaine include, but are not limited to, betaines having a tertiary amino group, such as dimethylglycine, dimethylalanine, dimethylglutamic acid, and diethylglycine; and betaines having a quaternary amino group, such as trimethylglycine, trimethylalanine, trimethylglutamic acid, and triethylglycine. In some embodiments, a betaine having a quaternary amino group, particularly trimethylglycine, may be used. The use of such a betaine tends to improve the moisture-retaining property and the hygroscopicity of the ink composition. Consequently, the printing head can be readily recovered from clogging by cleaning. A betaine may be used alone, or two or more betaines may be used in combination.

The carbon number of the betaine may be 3 to 12, for example, 3 to 7 or 4 to 6. Such betaines tend to make the ink composition stable to disturbances caused by contamination with chargeable foreign substances.

The betaine content in the ink composition may be 0.5% to 7.5%, for example, 1.0% to 5.0% or 1.5% to 3.0%, relative to the total mass of the ink composition. When the betaine content is in such a range, the ink composition is less likely to clog the printing head and tends to increase cleaning performance.

The total content of the room-temperature-solid polyhydric alcohols and betaines may be 0.5% to 7.5%, for example, 1.0% to 6.0% or 1.5% to 4.0%, relative to the total mass of the ink composition. When the total content of the room-temperature-solid polyhydric alcohols and betaines is in such a range, the ink composition tends to exhibit high moisture-retaining property and improved hygroscopicity and increase cleaning performance and is less likely to clog the printing head.

### 1. 1. 6. Pigment

The ink composition used in the present disclosure may further contain a pigment. Examples of the pigment include, but are not limited to, azo pigments, such as azo lake, insoluble azo pigments, condensed azo pigments, and chelate azo pigments; polycyclic pigments, such as phthalocyanine pigments, perylene pigments, perinone pigments, anthraquinone pigments, quinacridone pigments, dioxazine pigments, thioindigo pigments, isoindolinone pigments, and quinophthalone pigments; other organic pigments such as nitro pigments, nitroso pigments, and aniline black; carbon blacks, such as furnace black, thermal lamp black, acetylene black, and channel black; inorganic pigments, such as metal oxides, metal sulfides, and metal chlorides; and extender pigments, such as silica, calcium carbonate, and talc.

The pigment to be added to the ink may be in the form of a pigment dispersion liquid. The pigment dispersion liquid may be prepared by dispersing the particles of the pigment in water with a dispersant, by introducing hydrophilic groups to the surfaces of the pigment particles by a chemical reaction and dispersing thus prepared surface-treated self-dispersible pigment in water, or by coating the pigment particles with a polymer and dispersing the polymer-coated pigment in water.

The pigment and the dispersant used in the pigment dispersion each may be an individual substance or a combination of two or more substances.

The pigment content in the ink composition may be 1.0% to 12%, for example, 2.0% to 10% or 3.0% to 7.5%, relative to the total mass of the ink composition.

### 1. 1. 7. Water

The ink composition used in the present disclosure may further contain water. The water content in the ink composition may be 50% to 80%, for example, 60% to 80% or 65% to 75%, relative to the total mass of the ink composition.

### 1. 1. 8. Surfactant

The ink composition used in the present disclosure may further contain a surfactant. The surfactant may be, but is not limited to, an acetylene glycol-based surfactant, a fluorosurfactant, or a silicone surfactant. In some embodiments, an acetylene glycol-based surfactant may be used from the viewpoint of recovery from clogging.

The acetylene glycol-based surfactant may be, but is not limited to, at least one selected from the group consisting of 2,4,7,9-tetramethyl-5-decyne-4,7-diol and alkylene oxide adducts thereof, and 2,4-dimethyl-5-decyne-4-ol and alkylene oxide adducts thereof. The acetylene glycol-based surfactant is commercially available, and examples thereof include, but are not limited to, Olfine 104 series and Olfine E series, such as Olfine E1010 (all produced by Air Products and Chemicals Inc.); and Surfynol series 61, 104, and 465 (all produced by Evonik Industries). The acetylene glycol-based surfactant may be an individual compound or a combination of two or more compounds.

Examples of the fluorosurfactant include, but are not limited to, perfluoroalkylsulfonic acid salts, perfluoroalkylcarboxylic acid salts, perfluoroalkylphosphoric acid esters, perfluoroalkylethylene oxide adducts, perfluoroalkylbetaines, and perfluoroalkylamine oxides. Fluorosurfactants are commercially available, and examples thereof include, but are not limited to, S-144 and S-145 (both produced by Asahi Glass); FC-170C, FC-430, and Fluorad-FC4430 (all produced by Sumitomo 3M); FSO, FSO-100, FSN, FSN-100, and FS-300 (all produced by Dupont); and FT-250 and FT-251 (both produced by Neos). The fluorosurfactant may be an individual compound or a combination of two or more compounds.

The silicone surfactant may be a polysiloxane compound or a polyether-modified organosiloxane. The silicone surfactant is commercially available, and examples thereof include, but are not limited to, BYK-306, BYK-307, BYK-333, BYK-341, BYK-345, BYK-346, BYK-347, BYK-348, and BYK-349 (all produced by BYK Additives & Instruments); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all produced by Shin-Etsu Chemical).

The surfactant content in the ink composition may be 0.1% to 5.0%, for example, 0.1% to 3.0%, relative to the total mass of the ink composition. When the surfactant content is in such a range, the ink composition is likely to help recovery from clogging.

### 1. 1. 9. Preparation of the Ink Composition

The ink composition used in the present disclosure may be prepared by, but not limited to, mixing resin particles, an organic solvent having a normal boiling point of 280° C. or more, at least either an organic alkali or an inorganic alkali, at least either a betaine or a room-temperature-solid polyhydric alcohol, and other constituents. In an embodiment using a pigment, a dispersion liquid of the pigment may be added.

### 1. 2. Printing Head

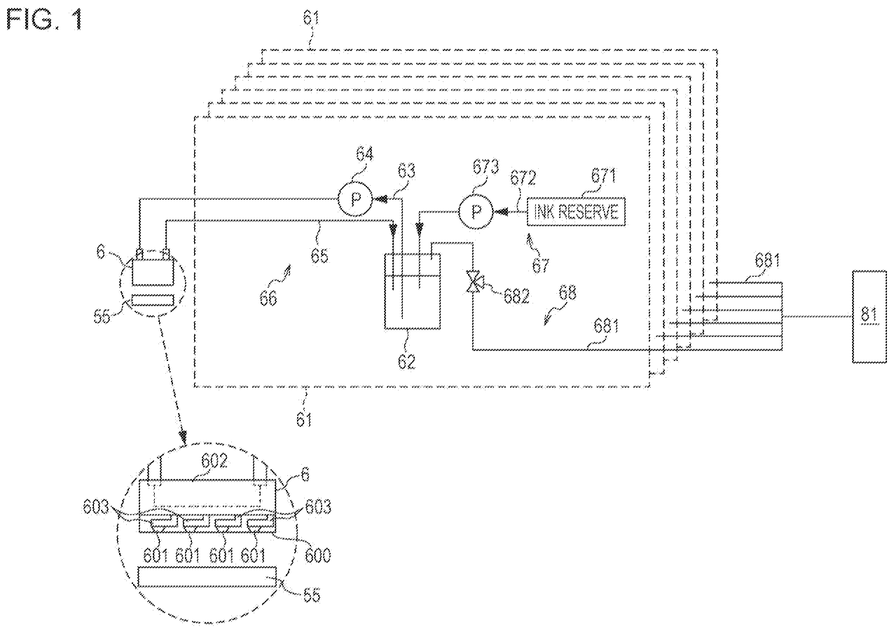

The printing head has nozzles through which the ink composition is ejected, and a nozzle face where the ejection openings of the nozzles are defined. FIG. 1 schematically illustrates an arrangement of a printing head and an ink delivery mechanism to the printing head.

A printing head 6 has nozzles 601 that are open at the nozzle face 600, a reservoir 602 in which the ink composition is temporarily held, and cavities 603 coupling the nozzles 601 and the reservoir 602. The ink composition is delivered to the nozzles 601 from the reservoir 602 through the cavities 603. In the operation for printing, the cavities 603 compress the ink composition, and the ink composition is thus ejected from the nozzles 601.

The nozzle face 600 may be provided with a liquid-repellent film (not shown) thereon. Any liquid-repellent film may be used without particular limitation, provided that it is repellent to liquid. For example, the liquid-repellent layer may be provided by forming a film of liquid-repellent metal alkoxide molecules, followed by drying and annealing. Any metal alkoxide molecular film may be formed, provided that the film is repellent to liquid. In some embodiments, the metal alkoxide molecular film may be a molecular film of a metal alkoxide having a long-chain fluorine-containing polymer group or a molecular film of metallate salt having a liquid-repellent group, such as a long-chain fluorine-containing polymer group.

The metal of the metal alkoxide is generally selected from, but is not limited to, silicon, titanium, aluminum, and zirconium. The long-chain fluorine-containing polymer group (long-chain FR group) may be a perfluoroalkyl chain or perfluoropolyether chain. An alkoxysilane having a long-chain RF group, such as a silane coupling agent having a long-chain RF group may be use. The liquid-repellent film may be, but not limited to, a silane coupling agent (SCA) film or a film disclosed in Japanese Patent No. 4424954. A film repellent, particularly, to water is referred to as a water-repellent film.

The liquid-repellent film may be formed on an electrically conductive film formed on a nozzle plate provided with nozzles therein or on a silicone underlayer previously formed by plasma polymerization of silicone material. The presence of such an underlayer film gives an affinity between the silicone material of the nozzle plate and the liquid-repellent film.

The thickness of the liquid-repellent film may be 1 nm to 30 nm, for example, 1 nm to 20 nm or 1 nm to 15 nm. Such a thickness of the liquid-repellent film tends to impart higher liquid repellency to the nozzle face, retarding the degradation of the film and maintaining the liquid repellency for a long time. Also, the liquid-repellent film with such a thickness is beneficial in terms of cost and ease of film formation.

The ink delivery mechanism includes printing heads 6 and ink delivery sections 61 provided, one each, for the printing heads 6. Ink compositions are delivered to the printing heads 6 from the respective ink delivery sections 61. For example, an individual ink delivery section 61 includes an ink tank 62 in which an ink composition is stored, a delivery channel 63 coupling the tank 62 and the reservoir 602 of the printing head 6, a liquid pump 64 provided for the delivery channel 63, and a recovery channel 65 coupling the reservoir 602 of the printing head 6 and the tank 62. Thus, a circulation pathway 66 is defined through which the ink composition flows in the following order: the tank 62, the delivery channel 63, the reservoir 602 of the printing head 6, the recovery channel 65, and the tank 62. The forward rotation of the liquid pump 64 circulates the ink composition through the circulation pathway 66. More specifically, the liquid pump 64 feeds the ink composition from the tank 62 to the printing head 6 through the delivery channel 63 (forward path) and returns the ink composition from the printing head 6 to the tank 62 through the recovery channel 65 (backward path).

The ink delivery section 61 also includes an ink supply mechanism 67 operable to supply the ink composition to the tank 62 and a pressure control mechanism 68 operable to control the pressure in the tank 62. The ink supply mechanism 67 includes an ink reserve 671, such as an ink cartridge or bag, that is replaceable or can be refilled, a supply channel (supply pipe) 672 coupling the ink reserve 671 and the tank 62, and a supply pump 673 provided for the supply channel 672. The forward rotation of the supply pump 673 feeds the ink composition from the ink reserve 671 to the tank 62 through the supply channel 672.

The printing head 6 may be a line head used for line printing or a serial head used for serial printing.

For line printing with a line head, for example, the printing head having a width more than or equal to the width of the printing medium is fixed to the printing apparatus. In this state, while the printing medium is moved in a sub-scanning direction (medium transport direction, the longitudinal direction of the printing medium), ink droplets are ejected through the nozzles of the printing head, thus printing images on the printing medium.

For serial printing with a serial head, the printing head is mounted on a carriage capable of moving across the width of the printing medium. In this state, while the carriage is moved in the main scanning direction (lateral or width direction of the printing medium), the printing head ejects ink droplets through the nozzles, thus printing images on the printing medium.

### 1. 2. Pressure Cleaning Mechanism

The pressure cleaning mechanism applies a pressure to the interior of the printing head to discharge the ink composition from the nozzles for cleaning. The pressure cleaning mechanism discharges the ink composition in a continuous flow instead of ejecting the ink composition in intermittent droplets, thus cleaning the printing head or nozzles more favorably than the intermittent ejection. Also, the pressure cleaning mechanism may further include a pressure control mechanism 68 apart from the ink ejection mechanism, such as cavities 603, used for easy pressure control in the ordinary printing operation. For the pressure cleaning, a higher pressure than the pressure from the ejection mechanism may be applied to the printing head. By applying a higher pressure than the pressure for ink ejection, cleaning performance is improved. The pressure cleaning mechanism described above is merely an example and does not limit the pressure cleaning mechanism of the subject matter of the present disclosure.

The pressure control mechanism 68 includes a pressure channel (pressuring pipe) 681 coupling a pressure buffer tank 81 and the ink tank 62, and a three-way valve 682 provided for the pressure channel 681. The pressure in the ink tank 62 is controlled by the operation of the three-way valve 682. More specifically, the three-way valve 682 switches between the path from the pressure buffer tank 81 to the ink tank 62 and the path through which air is introduced to the ink tank 62, selecting either path. For example, as the valve switches to the path from the pressure buffer tank 81 to the ink tank 62, the pressure in the ink tank 62 is increased by the pressure from the pressure buffer tank 81. In contrast, as the path is switched to the path for introducing atmospheric air into the ink tank 62, the ink tank 62 is opened to the atmosphere, returning the pressure in the tank 62 to atmospheric pressure.

For the pressure cleaning, a maintenance unit 55 is disposed under the printing head 6. The rotation of the liquid pump 64 is accelerated to a certain pressuring speed in the forward direction. This pressuring speed is higher than the normal rotational speed for the printing operation. Then, the maintenance unit 55 caps the nozzle face 600, and the pressure buffer tank 81 applies a pressure to the interior of the ink tank 62, thereby applying a pressure to the nozzles 601 from the ink tank 62 through the circulation pathway 65. As the capping is released, the ink composition in the nozzles 601 is discharged to the maintenance unit 55. At this time, air bubbles in the nozzles 601 are discharged together with the ink composition to be discharged from the nozzles 601.

### 1. 3. Wipe Cleaning Mechanism

The ink jet printing apparatus disclosed herein may further include a wipe cleaning mechanism operable to wipe the nozzle face with an absorbent member. This mechanism wipes the ink composition attached to the nozzle face 600 by being discharged or ejected from the nozzles 601 for pressure cleaning or printing operation. Thus, ejection failure caused by the ink composition attached to the nozzle face 600 is reduced. Since the absorbent member absorbs the ink composition, the ink composition is not likely to be pressed back into the nozzles, resulting in high cleaning performance.

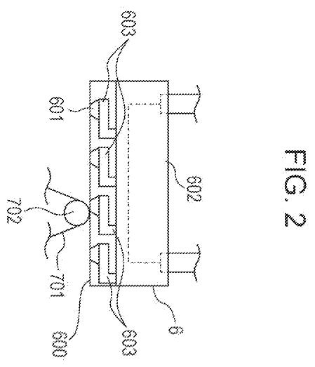

FIG. 2 schematically illustrates a wipe cleaning mechanism. The wipe cleaning mechanism includes an absorbent member 701 and a driving mechanism 702 operable to move the absorbent member 701 along the nozzle face 600, and optionally, a cleaning liquid supply tube.

The driving mechanism 702 moves at least one of the absorbent member 701 and the printing head 6 for relative movement so that the absorbent member can clean or remove the ink composition attached to the nozzle face.

The absorbent member 701 may be, but is not limited to, a cloth or a sponge. In some embodiment, a cloth may be used. The cloth is flexible and can, therefore, easily wipe the ink composition attached to the nozzle face particularly in a structure provided with a nozzle plate cover. The cloth may be made of, but is not limited to, cotton, cuprammonium, polyester, polyethylene, polypropylene, lyocell, rayon, or the like. A nonwoven fabric made of fibers of these materials may be used.

In some embodiments, the absorbent member 701 may be impregnated with a cleaning liquid. The use of a cleaning liquid helps remove the ink composition attached to the nozzle face 600 Also, the cleaning liquid helps the pigment particles at the surface of the absorbent member to migrate into the interior of the absorbent member. Thus, the pigment particles become unlikely to remain on the surface of the absorbent member. This effect appears remarkably when the ink composition contains resin particles having a glass transition temperature of −30° C. to 50° C. The resin particles having a glass transition temperature of −30° C. to 50° C. are likely to melt due to frictional heat generated at the interface between the absorbent member and the nozzle face when the ink composition is wiped, and the melted resin can stick on the nozzle face and solidifies. However, the cleaning liquid impregnating the absorbent member suppresses such adhesion or sticking of the resin particles.

The cleaning liquid may contain the water-soluble organic solvent used in the ink composition or water and a surfactant. Such a cleaning liquid further helps the absorbent member absorb the resin particles. Any cleaning liquid may be used, provided that it causes pigment particles to migrate from the surface into the interior of the absorbent member.

Examples of the water-soluble organic solvent used in the cleaning liquid include, but are not limited to, glycerin; glycols, such as ethylene glycol, triethylene glycol, propylene glycol, tripropylene glycol, propanediol, butanediol, pentanediol, and hexylene glycol; and lower alkyl ethers of glycols, such as ethylene glycol monomethyl ether, diethylene glycol monomethyl ether, diethylene glycol monoethyl ether, and diethylene glycol monobutyl ether.

The water-soluble organic solvent content may be 1% to 10%, for example, 3% to 7%, relative to the total mass of the cleaning liquid. The cleaning liquid may contain water, and the water content may be 85% to 99%, for example, 90% to 98%, relative to the total mass of the cleaning liquid. When the water-soluble organic solvent content and the water content are in the above ranges, cleaning performance tends to increase.

The surfactant used in the cleaning liquid may be selected from, but are not limited to, the surfactants presented as those used in the ink composition. The surfactant content may be 0.05% to 1.0% relative to the total mass of the cleaning liquid.

The surface tension S2 of the cleaning liquid may be 0.75 to 1.25, for example, 0.9 to 1.25 or 1.1 to 1.25 relative to the surface tension S1 of the ink composition. When the surface tension S2/S1 ratio is in such a range, the ink composition and the cleaning liquid have an affinity and tend to increase cleaning performance.

The surface tension S1 of the ink composition may be 20 mN/m to 40 mN/m, for example, 25 mN/m to 35 mN/m. The ink composition having such a surface tension tends to increase cleaning performance.

The surface tension S2 of the cleaning liquid may be 25 mN/m to 50 mN/m, for example, 30 mN/m to 42 mN/m. The cleaning liquid having such a surface tension tends to exhibit high cleaning performance.

The surface tensions S1 and S2 are those at 25° C. The surface tensions can be measured by the method that will be described herein in Examples.

The contact angle C2 of the cleaning liquid with the nozzle face may be 1.1 to 2.0, for example, 1.3 to 1.7 or 1.5 to 1.7, relative to the contact angle C1 of the ink composition with the nozzle face. When the contact angle C2/C1 ratio is in such a range, the resin particles in the ink composition are less likely to remain on the nozzle face, and cleaning performance tends to increase.

The contact angle C1 of the ink composition with the nozzle face may be 50° to 80°, for example, 55° to 75° or 60° to 70°. When the contact angle C1 is in such a range, the resin particles in the ink composition are less likely to remain on the nozzle face, and cleaning performance tends to increase.

The contact angle C2 of the cleaning liquid with the nozzle face may be 80° to 130°, for example, 90° to 120° or 100° to 110°. When the contact angle C2 is in such a range, cleaning performance tends to increase.

The contact angles C1 and C2 are those at 25° C. The contact angles can be measured by the method that will be described herein in Examples.

The surface tensions S1 and S2 and the contact angles C1 and C2 can be appropriately adjusted according to the types and amounts of the surfactant, the organic solvent, and other constituents in the ink composition and the cleaning liquid.

### 2. Maintenance Method

The maintenance method disclosed herein is intended to maintain an ink jet printing apparatus using the above-described ink composition and includes a pressure cleaning step of applying a pressure to the interior of the printing head to discharge the ink composition from the nozzles. The maintenance method enables favorable recovery from clogging and provides high cleaning performance even when an ink composition that can increase fastnesses to rubbing and washing is used.

The maintenance method may further include a wipe cleaning step of wiping the nozzle face with an absorbent member before and after the pressure cleaning. Thus, the ink composition attached to the nozzle face in the pressure cleaning step or during printing operation can be removed.

### EXAMPLES

The subject matter of the present disclosure will be further described in detail with reference to Examples and Comparative Examples. However, the implementation of the concept of the present disclosure is not limited to the following Examples.

### 1. Preparation of Ink Compositions

For preparing each ink composition, the constituents were placed into a mixing tank and mixed and stirred so that the resulting mixture would have the composition presented in Table 1 and 2, and the mixture was filtered through a membrane filter with a pore size of 5 μm. The values of the constituents presented in the Tables are represented by mass percent unless otherwise specified. The values of the pigment dispersion liquid and the resin particles are their respective solid contents represented by mass percent.

TABLE 1

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Ink | | A | A | A | B | C | D | E | F | G | H | I |
| Pigment dispersion | Cyan pigment | 4.0 | 4.0 | 4.0 | 4.0 | 4.0 | 4.0 | 4.0 | 4.0 | 4.0 | 4.0 | 4.0 |
| liquid | (solids) | | | | | | | | | | | |
| Resin particles | Resin particles A | 4.0 | 4.0 | 4.0 | 3.0 | 7.0 | | 4.0 | 4.0 | 4.0 | 4.0 | 4.0 |
| | Resin particle B | — | — | — | — | — | 4.0 | — | — | — | — | — |
| | Resin particle C | — | — | — | — | — | — | — | — | — | — | — |
| Organic solvent | Glycerin | 10.0 | 10.0 | 10.0 | 10.0 | 10.0 | 10.0 | 10.0 | 10.0 | 10.0 | 10.0 | 10.0 |
| (normal boiling point: | | | | | | | | | | | | |
| 280° C. or more) | | | | | | | | | | | | |
| Polyhydric alcohol | Trimethylolpropane | 2.5 | 2.5 | 2.5 | 2.5 | 2.5 | 2.5 | 1.5 | 6.0 | — | — | 2.5 |
| (solid at room | Trehalose | — | — | — | — | — | — | — | — | 2.5 | — | — |
| temperature) | | | | | | | | | | | | |
| Betaine | Trimethylglycine | — | — | — | — | — | — | — | — | — | 2.5 | — |
| Organic alkali | 2-Aminoethanol | 0.5 | 0.5 | 0.5 | 0.5 | 0.5 | 0.5 | 0.5 | 0.5 | 0.5 | 0.5 | 0.2 |
| Inorganic alkali | Potassium hydroxide | — | — | — | — | — | — | — | — | — | — | — |
| Surfactant | Surfactant A | 0.3 | 0.3 | 0.3 | 0.3 | 0.3 | 0.3 | 0.3 | 0.3 | 0.3 | 0.3 | 0.3 |
| | Surfactant B | — | — | — | — | — | — | — | — | — | — | — |
| Water | | Balance | Balance | Balance | Balance | Balance | Balance | Balance | Balance | Balance | Balance | Balance |
| Total of organic and inorganic alkalis/total | | 0.2 | 0.2 | 0.2 | 0.2 | 0.2 | 0.2 | 0.3 | 0.1 | 0.2 | 0.2 | 0.1 |
| of polyhydric alcohol and betaine | | | | | | | | | | | | |
| Resin particles/total of polyhydric alcohol | | 1.6 | 1.6 | 1.6 | 1.2 | 2.8 | 1.6 | 2.7 | 0.7 | 1.6 | 1.6 | 1.6 |
| and betaine | | | | | | | | | | | | |
| Ink jet printing | Pressure or vacuum | Pressure | Pressure | Pressure | Pressure | Pressure | Pressure | Pressure | Pressure | Pressure | Pressure | Pressure |
| apparatus | Absorbent member + | ✓ | | | ✓ | ✓ | ✓ | ✓ | ✓ | ✓ | ✓ | ✓ |
| constitution | cleaning liquid | | | | | | | | | | | |
| | Absorbent member + | | ✓ | | | | | | | | | |
| | pure water | | | | | | | | | | | |
| | Wiping blade | | | ✓ | | | | | | | | |
| Physical properties | Surface tension ratio | 1.2 | 1.2 | 1.2 | 1.2 | 1.2 | 1.2 | 1.2 | 1.2 | 1.2 | 1.2 | 1.2 |
| | (S2/S1) | | | | | | | | | | | |
| | Ink composition | 65 | 65 | 65 | 65 | 65 | 65 | 65 | 65 | 65 | 65 | 65 |
| | contact angle C1 | | | | | | | | | | | |
| | Cleaning liquid | 104 | 104 | 104 | 104 | 104 | 104 | 104 | 104 | 104 | 104 | 104 |
| | contact angle C2 | | | | | | | | | | | |
| | Contact angle ratio | 1.6 | 1.6 | 1.6 | 1.6 | 1.6 | 1.6 | 1.6 | 1.6 | 1.6 | 1.6 | 1.6 |
| | (C2/C1) | | | | | | | | | | | |
| Evaluation | Anti-clogging | A | A | A | A | B | A | B | B | B | B | B |
| | Cleaning ability | A | B | B | A | A | A | A | A | A | A | A |
| | Fastness to rubbing | A | A | A | B | A | B | A | A | A | A | A |
| | Fastness to washing | A | A | A | B | A | B | A | A | A | A | A |
| | Texture | B | B | B | B | B | A | B | B | B | B | B |

TABLE 2

| | | | | | | | | | | | Reference |
|---|---|---|---|---|---|---|---|---|---|---|---|
| | | Example | | | | Comparative Example | | | | | Example |
| | | 12 | 13 | 14 | 15 | 1 | 2 | 3 | 4 | 5 | 1 |
| Ink | | J | K | L | M | N | O | P | Q | R | A |
| Pigment dispersion liquid | Cyan pigment (solids) | 4.0 | 4.0 | 4.0 | 4.0 | 4.0 | 4.0 | 4.0 | 4.0 | 4.0 | 4.0 |
| Resin particles | Resin particles A | 4.0 | 4.0 | 4.0 | 4.0 | — | — | 4.0 | 4.0 | 4.0 | 4.0 |
| | Resin particle B | | | | | | | | | | |
| | Resin particle C | — | — | — | — | 4.0 | — | — | — | — | — |
| Organic solvent (normal | Glycerin | 10.0 | 10.0 | 10.0 | 10.0 | 10.0 | 10.0 | — | 10.0 | 10.0 | 10.0 |
| boiling point: 280° C. | | | | | | | | | | | |
| or more) | | | | | | | | | | | |
| Polyhydric alcohol (solid | Trimethylolpropane | 2.5 | 2.5 | 2.5 | 2.5 | 2.5 | 2.5 | 2.5 | — | 2.5 | 2.5 |
| at room temperature) | Trehalose | — | — | — | — | — | — | — | — | — | — |
| Betaine | Trimethylglycine | — | — | — | — | — | — | — | — | — | — |
| Organic alkali | 2-Aminoethanol | 2.0 | — | 0.5 | 0.5 | 0.5 | 0.5 | 0.5 | 0.5 | — | 0.5 |
| Inorganic alkali | Potassium hydroxide | — | 0.1 | 0.1 | — | — | — | — | — | — | — |
| Surfactant | Surfactant A | 0.3 | 0.3 | 0.3 | — | 0.3 | 0.3 | 0.3 | 0.3 | 0.3 | 0.3 |
| | Surfactant B | — | — | — | 0.3 | — | — | — | — | — | — |
| Water | | Balance | Balance | Balance | Balance | Balance | Balance | Balance | Balance | Balance | Balance |
| Total of organic and inorganic alkalis/total of | | 0.8 | 0.04 | 0.2 | 0.2 | 0.2 | 0.2 | 0.2 | — | — | 0.2 |
| polyhydric alcohol and betaine | | | | | | | | | | | |
| Resin particles/total of polyhydric alcohol | | 1.6 | 1.6 | 1.6 | 1.6 | 1.6 | — | 1.6 | — | 1.6 | 1.6 |
| and betaine | | | | | | | | | | | |
| Ink jet printing apparatus | Pressure or vacuum | Pressure | Pressure | Pressure | Pressure | Pressure | Pressure | Pressure | Pressure | Pressure | Vacuum |
| constitution | Absorbent member + | ✓ | ✓ | ✓ | ✓ | ✓ | ✓ | ✓ | ✓ | ✓ | ✓ |
| | cleaning liquid | | | | | | | | | | |
| | Absorbent member + | | | | | | | | | | |
| | pure water | | | | | | | | | | |
| | Wiping blade | | | | | | | | | | |
| Physical properties | Surface tension ratio | 1.2 | 1.2 | 1.2 | 1 | 1.2 | 1.2 | 1.2 | 1.2 | 1.2 | 1.2 |
| | (S2/S1) | | | | | | | | | | |
| | Ink composition contact | 65 | 65 | 65 | 75 | 65 | 65 | 65 | 65 | 65 | 65 |
| | angle C1 | | | | | | | | | | |
| | Cleaning liquid contact | 104 | 104 | 104 | 104 | 104 | 104 | 104 | 104 | 104 | 104 |
| | angle C2 | | | | | | | | | | |
| | Contact angle ratio | 1.6 | 1.6 | 1.6 | 1.4 | 1.6 | 1.6 | 1.6 | 1.6 | 1.6 | 1.6 |
| | (C2/C1) | | | | | | | | | | |
| Evaluation | Anti-clogging | B | A | A | A | A | A | C | C | B | A |
| | Cleaning ability | A | B | A | B | A | A | C | C | C | A |
| | Fastness to rubbing | B | A | A | A | C | C | B | A | A | A |
| | Fastness to washing | B | A | A | A | C | C | B | A | A | A |
| | Texture | B | B | B | B | C | A | B | B | B | B |

The abbreviations and materials of the constituents presented in the Tables are as follows:

### Pigment Dispersion Liquid

Cyan Pigment: 15 mass % pigment dispersion prepared by mixing 65 parts of C. I. Pigment Black 15:3 with 35 parts of styrene-acrylic resin dispersion JONCRYL 611 (produced by BASF), 1.70 parts of potassium hydroxide, and 250 parts of ultra-pure water purified from ion-exchanged water by reverse osmosis and dispersing the mixture in a ball mill with zirconia beads for 10 hours, followed by removing coarse particles through a glass fiber filter GA-100 (produced by Advantec Toyo).

### Resin Particles

Resin particles A (AKELAC WS-6021 produced by Mitsui Chemicals, Inc., having a self-crosslinkable group and a glass transition temperature of 40° C.)

Resin particles B (AKELAC W-6110 produced by Mitsui Chemicals, Inc., having no self-crosslinkable group and a glass transition temperature of −20° C.)

Resin particles C (AKELAC W-605 produced by Mitsui Chemicals, Inc., having no self-crosslinkable group and a glass transition temperature of 100° C.)
Organic Solvent Having Normal Boiling Point of 280° C. or More Glycerin

### Room-Temperature Solid Polyhydric Alcohol

Trimethylolpropane

Trehalose

### Betaine

Trimethylglycine (betaine anhydride, produced by Tokyo Chemical Industry)

### Organic Alkali

2-Amino ethanol

### Inorganic Alkali

Potassium hydroxide

### Surfactant

Surfactant A (BYK 348 produced by BYK, silicone surfactant)

Surfactant B (SURFYNOL 465 produced by Evonik Industries, acetylene glycol-based surfactant)

In the Tables, “Total of organic and inorganic alkalis/total of polyhydric alcohol and betaine” represents the proportion of the total mass of the organic and inorganic alkalis to the total mass of the room-temperature-solid polyhydric alcohol and the betaine. In the Tables, “Resin particles/total of polyhydric alcohol and betaine” represents the proportion of the total mass of the resin particles to the total mass of the room-temperature-solid polyhydric alcohol and the betaine.

### 1. 1. Surface Tension and Surface Tension Ratio

The surface tensions presented in the Tables were measured by a Wilhelmy method using a surface tensiometer CBVP-Z (manufactured by Kyowa Interface Science) at a liquid temperature of 25° C. The surface tension ratio (S2/S1) was calculated from the surface tension S1 of the ink composition and the surface tension S2 of the cleaning liquid.

1. 2. Contact angle and Contact Angle Ratio

The contact angles presented in the Tables were measured at 25° C. with a portable contact angle meter PCA-1 (manufactured by Kyowa Interface Science). For measuring contact angles, a monocrystalline silicon nozzle plate provided with a water-repellent film was used as the nozzle face. A silicon oxide (SiO₂) film was formed on the surface on the ink ejection side of the nozzle plate by chemical vapor deposition (CVD) conducted by introducing SiCl₄ and water vapor into a CVD reactor. The thickness of the SiO₂ film was 50 nm. The SiO₂ film was further subjected to oxygen plasma treatment and then CVD using C₈F₁₇C₂H₄SiCl₃ to form a water-repellent film. The silicon nozzle plate with the water-repellent film thus prepared was used. The contact angle ratio (C2/C1) was calculated from the contact angle C1 of the ink composition and the contact angle C2 of the cleaning liquid.

### 2. Preparation of Cleaning Liquid

The cleaning liquid presented in the Tables was prepared by mixing 5% by mass of glycerin, 0.1% by mass of SURFYNOL 465, and 94.9% by mass of water.

### 3. Ink Jet Printing Apparatus

Ink jet printing apparatuses having a pressure cleaning mechanism and a wipe cleaning mechanism were prepared. More specifically, there were prepared an ink jet printing apparatus using an absorbent member impregnated with the cleaning liquid as the wipe cleaning mechanism, an ink jet printing apparatus using an absorbent member impregnated with water as the wipe cleaning mechanism, and an ink jet printing apparatus using a wiping blade as the wipe cleaning mechanism, instead of an absorbent member. For Reference Example 1, an ink jet printing apparatus having a vacuum cleaning mechanism instead of the pressure cleaning mechanism was prepared. The Tables present the cleaning functions provided for each ink jet printing apparatus of the Examples and Comparative Examples.

### 4. Evaluation

### 4. 1. Anti-Clogging

Each ink composition presented in Tables 1 and 2 was continuously printed on a cloth of 25° C. (room temperature) at the surface for one hour with an ink jet printer SC-F2000. After the printing, a nozzle line (360 nozzles) was checked for abnormal ejection (ejection failure). All the nozzles were normal at the beginning of the printing, and the results were evaluated according to the following criteria:

A: No abnormal ejection occurred at any nozzle.

B: Abnormal ejection occurred at one to five nozzles.

C: Abnormal ejection occurred at six or more nozzles.

### 4. 2. Cleaning Performance

Each ink composition was introduced into all nozzle lines of the print head of an ink jet printer (PX-S840, manufactured by Seiko Epson), and it was confirmed that the ink composition was normally ejected from all the lines. Then, the print head was stopped in the printing region away from the standby position and allowed to stand in an environment of 40° C. and 20% RH for three days. After being allowed to stand, the print head was returned to the standby position and subjected to pressure cleaning and, subsequently, wipe cleaning. The absorbent member used for the wipe cleaning was a cotton nonwoven fabric. In the series of cleaning operations, the number of times of cleaning until normal ejection was recovered was counted. The ink jet printer used for evaluation was modified to have the pressure cleaning mechanism and the wipe cleaning mechanism.

A: All the nozzles recovered by cleaning three times or less.

B: All the nozzles recovered by cleaning 4 to 10 times.

C: Nozzles did not recover even by cleaning 11 times or more.

### 4. 3. Fastness to Rubbing

The ink compositions were applied onto a cotton cloth by an ink jet method using an ink jet printer (PX-G930 manufactured by Seiko Epson). More specifically, a solid pattern image was formed with four coating layers of the ink composition in an A4-size printing region at a resolution of 1440 dpi by 720 dpi. Thus, ink jet textile printing was performed. A solid pattern image mentioned herein refers to an image formed by filling all the pixels, which are minimum printing unit regions, defined by the printing resolution with printed dots.

Then, the cloth was heat-treated at 165° C. for 5 minutes using a heat press machine to fix the ink composition. Thus, image-printed textiles (printed with an ink) were produced.

Each printed textile was subjected to color fastness tests with a crock meter in accordance with ISO-105 X12. The color fastness of the printed cloth against dry rubbing was tested in accordance with the dry rubbing test specified in ISO-105 X12 and evaluated under the grey scale. Evaluation criteria are as follows:

A: The fastness to rubbing was categorized 4 or higher.

B: The fastness to rubbing was categorized from 2 to less than 4.

C: The fastness to rubbing was categorized less than 2.

### 4. 4. Fastness to Washing

Each printed textile was subjected to color fastness tests against washing in accordance with Test A-2 specified in JIS L 0844 (method for color fastness to washing and laundering). More specifically, the test pieces of the printed textiles were washed, rinsed, dehydrated, and dried, and then the discoloration and fading of the printed portion on the test pieces were determined. Discoloration was evaluated under the grey scale for assessing color change of JIS L0804: 2004 (ISO 105-A02: 1993) and rated according to the following criteria:

A: The fastness to washing was categorized 4 or higher.

B: The fastness to washing was categorized from 2 to less than 4.

C: The fastness to washing was categorized less than 2.

### 4. 5. Texture

The texture of each printed textile was evaluated.

A: The texture of the printed textile was almost the same as that of the original cloth.

B: The texture of the printed textile seemed to be slightly harder than that of the original cloth.

C: The texture of the printed textile was harder than that of the original cloth.

D: The texture of the printed textile was definitely harder than that of the original cloth.

### 3. Evaluation Results

The Tables present the constituents and their proportions of the ink compositions and the constitutions of the ink jet printing apparatus, used in the Examples, Comparative Examples, and Reference Example and the evaluation results. The Tables suggest that a combination of an ink composition containing resin particles having a glass transition temperature of −30° C. to 50° C., an organic solvent having a normal boiling point of 280° C. or more, at least either an organic alkali or an inorganic alkali, and at least either a betaine or a room-temperature-solid polyhydric alcohol with an ink jet printing apparatus using a pressure cleaning mechanism can produce printed items with high fastness to rubbing while exhibiting high cleaning performance (recovery from clogging).

More specifically, the comparison between the Examples and Comparative Examples 1 and 2 suggests that the use of resin particles having a glass transition temperature of −30° C. to 50° C. improves the fastnesses to rubbing and washing and the texture of printed items.

The comparison between the Examples and Comparative Example 3 suggests that the use of an organic solvent having a normal boiling point of 280° C. or more reduces clogging and increases cleaning performance. The comparison between the Examples and Comparative Examples 4 and 5 suggests that the combined use of at least either an organic alkali or an inorganic alkali and at least either a betaine or a room-temperature-solid polyhydric alcohol reduces clogging and increases cleaning performance. In particular, for the organic solvent having a normal boiling point of 280° C. or more, at least one of organic and inorganic alkalis, and at least one betaines and room-temperature-solid polyhydric alcohols, it is suggested that the absence of any of them results in increased clogging and reduced cleaning performance.

In Reference Example 1, which used vacuum cleaning, the cleaning performance was good, but the cleaning time was longer than that in the case of using pressure cleaning. The increased cleaning time includes the time for removing air bubbles that were formed in the ink composition by the vacuum cleaning and attached to the nozzle face. Also, some of the nozzles failed in ejection when the cleaning performance test was repeated.

The comparison among Examples 1 to 3 suggests that the use of an absorbent member impregnated with the cleaning liquid further increases cleaning performance.

What is claimed is:

1. An ink jet printing apparatus, comprising:
a printing head having a nozzle face and a nozzle having an ejection opening defined in the nozzle face and through which an ink composition is ejected; and
a pressure cleaning mechanism configured to apply a pressure to an interior of the printing head to discharge the ink composition from the nozzle for cleaning,
wherein
the ink composition contains resin particles having a glass transition temperature of −30° C. to 50° C., an organic solvent having a normal boiling point of 280° C. or more, at least one of organic alkali and inorganic alkalis, and at least one of betaines and polyhydric alcohols being solid at room temperature.

2. The ink jet printing apparatus according to claim 1, wherein
the resin particles contain a crosslinkable group.

3. The ink jet printing apparatus according to claim 1, wherein
the resin particles include urethane resin particles.

4. The ink jet printing apparatus according to claim 1, wherein
the resin particle content is 3.0% to 8.0% relative to the total mass of the ink composition.

5. The ink jet printing apparatus according to claim 1, wherein
the total content of the organic and inorganic alkalis is, by mass, 0.10 to 0.60 relative to the total content of the polyhydric alcohols and betaines.

6. The ink jet printing apparatus according to claim 1, wherein
the resin particle content is, by mass, 1.0 to 2.0 relative to the total content of the polyhydric alcohols and betaines.

7. The ink jet printing apparatus according to claim 1, further comprising:
a wipe cleaning mechanism including an absorbent member and operable to wipe the nozzle face with the absorbent member.

8. The ink jet printing apparatus according to claim 7, wherein
the absorbent member is impregnated with a cleaning liquid having a surface tension of 0.75 to 1.25 relative to the surface tension of the ink composition.

9. The ink jet printing apparatus according to claim 8, wherein
the contact angle of the cleaning liquid with the nozzle face is 1.3 to 1.7 relative to the contact angle of the ink composition with the nozzle face.

10. A method for maintaining the ink jet printing apparatus as set forth in claim 1, the method comprising:
a pressure cleaning step of applying a pressure to an interior of the printing head to discharge the ink composition from the nozzle.
